(19) United States
(12) Patent Application Publication
(10) Pub. No.: US 2015/0029311 A1
(43) Pub. Date: Jan. 29, 2015

(54) IMAGE PROCESSING METHOD AND IMAGE PROCESSING APPARATUS

(71) Applicant: MEDIATEK INC., Hsin-Chu (TW)

(72) Inventors: Chao-Chung Cheng, Tainan City (TW); Te-Hao Chang, Taipei City (TW); Ying-Jui Chen, Hsinchu County (TW)

(73) Assignee: MEDIATEK INC., Hsin-Chu (TW)

(21) Appl. No.: 14/219,001

(22) Filed: Mar. 19, 2014

Related U.S. Application Data
(60) Provisional application No. 61/858,587, filed on Jul. 25, 2013.

(51) Int. Cl. H04N 13/02; H04N 5/232

(52) U.S. Cl. CPC H04N 13/0271; H04N 5/23229
USPC 348/46; 348/222.1

(57) ABSTRACT

An image processing method comprising: (a) receiving at least one input image; (b) acquiring depth map from the at least one input image; and (c) performing a defocus operation according to the depth map upon one of the input images, to generate a processed image.

### CROSS REFERENCE TO RELATED APPLICATIONS

This application claims the benefit of U.S. Provisional Application No. 61/858,587, filed on Jul. 25, 2013, the contents of which are incorporated herein by reference.

### BACKGROUND

The present application relates to an image processing method and an image processing apparatus for processing at least one input image to generate a processed image, and more particularly, to an image processing method and image processing apparatus for performing a defocus operation to generate a processed image according to depth map acquired from the at least two input image.

With development of the semiconductor technology, more functions are allowed to be supported by a single electronic device. For example, a mobile device (e.g., a mobile phone) can be equipped with a digital image capturing device such as a camera. Hence, the user can use the digital image capturing device of the mobile device for capturing an image. It is advantageous that the mobile device is capable of providing additional visual effects for the captured images. For example, blurry backgrounds are in most cases a great way to enhance the importance of the main subject and to get rid of distractions in the background, or make the image looks more artistic. Such effect always needs a large, expensive lens, which is hard to be disposed in a mobile phone. Or, the blurry backgrounds can be achieved via performing post-processing upon the captured image to create blurry backgrounds. However, the conventional post-processing scheme generally requires a complicated algorithm, which consumes much power and resource. Thus, there is a need for an innovative image processing scheme which can create the blurry backgrounds for the captured images in a simple and efficient way.

### SUMMARY

One objective of the present application is providing an image processing method and an image processing apparatus performing a defocus operation according to depth map for at least one input image, to control a defocus level or a focal point for an image.

One embodiment of the present application discloses an image processing method, which comprises: (a) receiving at least one input image; (b) acquiring depth map from the at least one input image; and (c) performing a defocus operation according to the depth map upon one of the input images, to generate a processed image.

Another embodiment of the present application discloses an image processing apparatus, which comprises: a receiving unit, for receiving at least one input image; a depth map acquiring unit, for acquiring depth map from the at least one input image; and a control unit, for performing a defocus operation according to the depth map upon one of the input images, to generate a processed image.

In view of above-mentioned embodiments, via performing defocus operation according to depth map, the focal point and the defocus level (depth of filed) can be easily adjusted by a user without an expensive lens and complex algorithms. Also, the 2D images for generating the depth map can be captured by a single camera with a single lens, thus the operation is more convenient for an user and the cost, size for the electronic apparatus in which the camera is disposed can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart illustrating an image processing method according to one embodiment of the present application.

FIG. 2(a), FIG. 2 (b) are schematic diagrams illustrating a more detail operation for the image processing method illustrated in FIG. 1, according to one embodiment of the present invention.

FIG. 2(c) is a schematic diagram illustrating an example of depth map

FIG. 3 is a schematic diagram illustrating the input image, the depth map, and processed images with different focal point and defocus levels, according to one embodiment of the present application.

FIG. 4 is a schematic diagram illustrating an example for adjusting a focal point of an image.

FIG. 5 is a schematic diagram illustrating an example for adjusting a defocus level of an image.

FIG. 6 is a block diagram illustrating an image processing apparatus according to one embodiment of the present application.

FIG. 7-FIG. 10 are schematic diagrams illustrating the generation for input images according to different embodiment of the present application.

### DETAILED DESCRIPTION

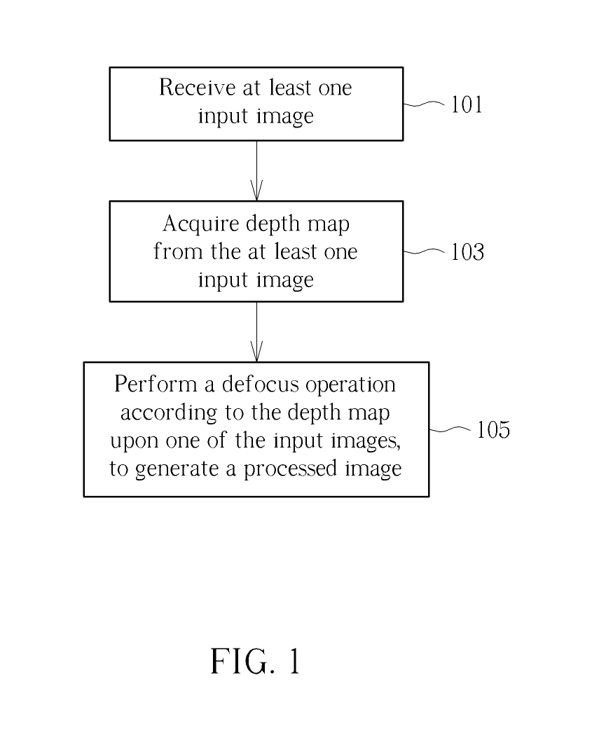

FIG. 1 is a flow chart illustrating an image processing method according to one embodiment of the present application. As shown in FIG. 1, the image processing method comprises the following steps:

Step 101

Receive at least one input image.

Step 103

Acquire depth map from the at least one input image.

Step 105

Perform a defocus operation according to the depth map upon one of the input images, to generate a processed image.

For the step 101, the input images can be at least two 2D images captured by a single image capturing device or different image capturing devices. Alternatively, the input image can be a 3D image.

For the step 103, if the input images are 2D images, the depth map can be acquired via computing disparity between two 2D images. Also, when the input image is a 3D image, the depth map can be extracted from the 3D image, wherein the 3D image can already have depth information or the 3D image can be transformed from two 2D images (i.e. a left image and a right image), or the 3D image can be transformed from one 2D image using 2D-to-3D conversion method.

For the step 105, if the input images are 2D images, the defocus operation according to the depth map is performed to one of the 2D images. Alternatively, if the input image is a 3D image, the defocus operation according to the depth map is performed to the 3D image.

The method in FIG. 1 can further comprise referring movement information to acquire the depth map. For example, if the image processing method is applied to an electronic apparatus such as a mobile phone. The method in FIG. 1 can be used to compute movement information from moving sensors, such as gyro, G-sensor or GPS, and the movement information can be further used for the electronic apparatus as reference for acquiring the depth map. Since the movement for the electronic apparatus may affect the acquiring for the depth map. Such step is advantageous for acquiring more precise depth map.

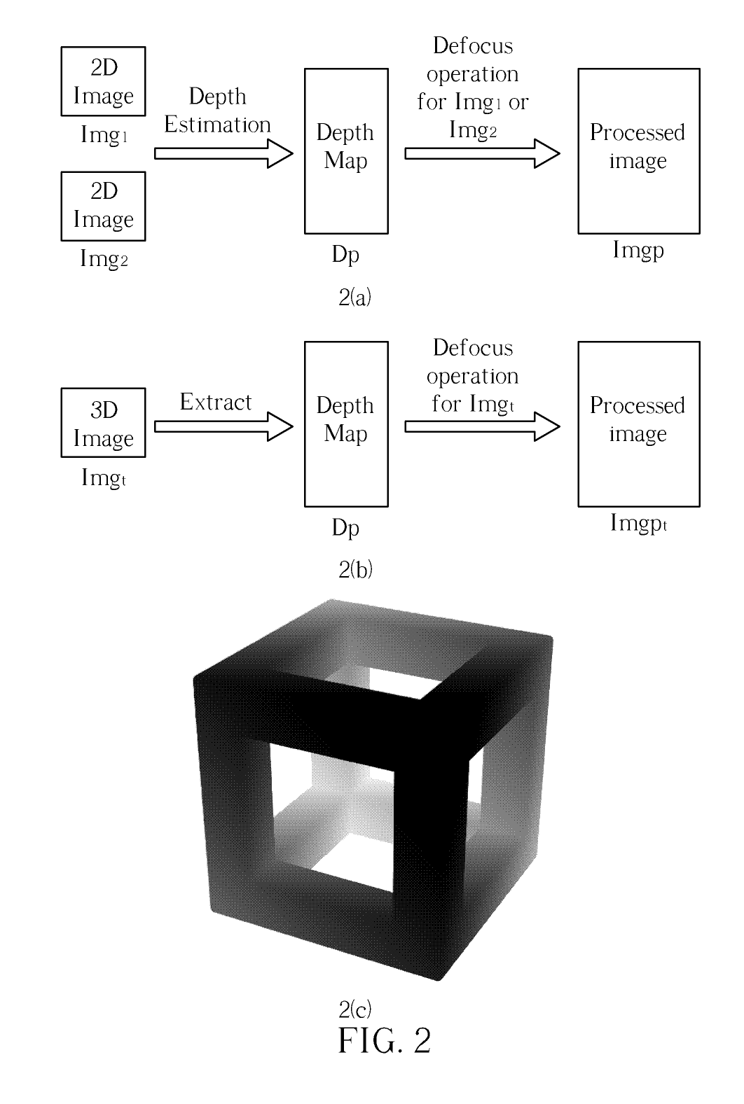

FIG. 2 is a schematic diagram illustrating a more detail operation for the image processing method illustrated in FIG. 1, according to one embodiment of the present invention. FIG. 2 comprises two sub diagrams FIG. 2(a) and FIG. 2(b). In FIG. 2(a), the input images are two 2D images Img₁, Img₂, which can be regarded as a left image and a right image. In FIG. 2(b), the input image is an original 3D image Imgt with depth information already. As shown in FIG. 2(a), the depth map DP is acquired via performing depth estimation to the 2D images Img₁, Img₂. The defocus operation according to the depth map DP is performed upon one of the 2D images Img₁, Img₂ to generate a processed image Imgp, which is also a 2D image in this embodiment. In FIG. 2(b), the depth map DP is extracted from the original 3D Imgt and the defocus operation according to the depth map DP is performed upon the original 3D Imgt to generate a processed image Imgpt, which is a 3D image. The 2D images Img₁, Img₂ can be captured by different kinds of methods, which will be described later.

Depth map is a grey scale image indicating distances between objects in the images. Via referring to the depth map, disparity for human eyes can be estimated and simulated while converting 2D images to 3D images, such that 3D images can be generated. Please refer to FIG. 2(c), which illustrates an example of depth map. The depth map in FIG. 11 shows luminance in proportion to the distance from the camera. Nearer surfaces are darker, and further surfaces are lighter. In FIG. 2(a), the depth map is applied for generating the 2D processed image Imgt, rather than generating a 3D image.

The operations in FIG. 2 can be implemented by many manners. For example, depth cue, Z-buffer, graphic layer information can be applied to generate depth map from 2D images. Additionally, the operation of extracting depth map from 3D images can be implemented by stereo matching from at least 2 views, or the depth map can be extracted from original source (ex. 2D images plus depth map based on 2D images that are applied to generate the original 3D image). However, please note the operations in FIG. 2 are not limited to be performed via these manners.

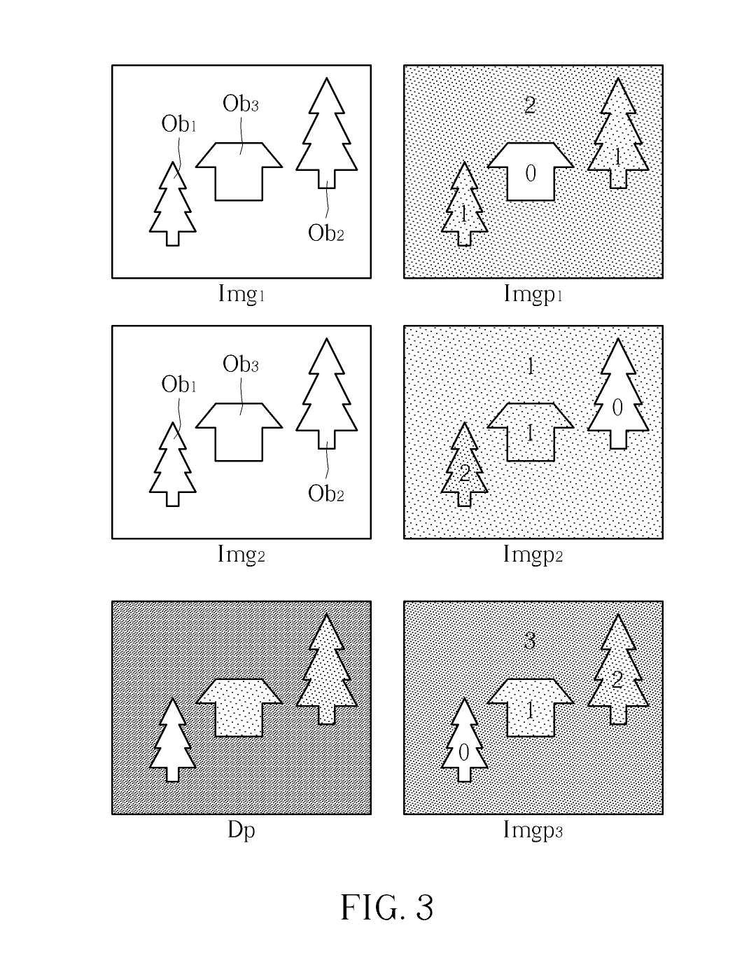

FIG. 3 is a schematic diagram illustrating the input image, the depth map, and processed images with different focal points and defocus levels, according to one embodiment of the present application. Please note in FIG. 3, two 2D images Img₁ and Img₂ are taken as an example for explaining, but the rules can be applied to the above-mentioned original 3D image as well. As shown in FIG. 3, the 2D images Img₁, Img₂ comprise objects Ob₁, Ob₂, Ob₃. Comparing with the 2D image Img₁, the objects Ob₁, Ob₂, Ob₃ in the Img₂ are shifted. By this way, the depth map DP can be generated. For the depth map DP, if the color is darker, it means the object is farther from a specific planar (ex. the planar at which the user is watching the image). The processed images Imgp₁, Imgp₂, and Imgp₃ respectively have different focal points and defocus levels. Please note the numbers 0, 1, 2 indicate different defocus levels. 0 is clearest, and 2 is most blurred. Therefore, for the processed image Imgp₁, if the object Ob₃ is desired to be focused and set to be a focal point (defocus level 0), the objects Ob₁ and Ob₂ are more blurred than the object Ob₃ (defocus level 1), and the background is most blurred (defocus level 2). For the processed image Imgp₂ , if the object Ob₂ is desired to be focused and set to be a focal point (defocus level 0), the objects Ob₃ and the background are more blurred than the object Ob₂ (defocus level 1), and the object Ob₁ is most blurred (defocus level 2). For the processed image Imgp₃, if the object Ob₁ is desired to be focused and set to be a focal point (defocus level 0), the objects Ob₃ is more blurred than the object Ob₁ (defocus level 1), the objects Ob₂ is more blurred than the object Ob₁ (defocus level 2), and the background is most blurred (defocus level 3).

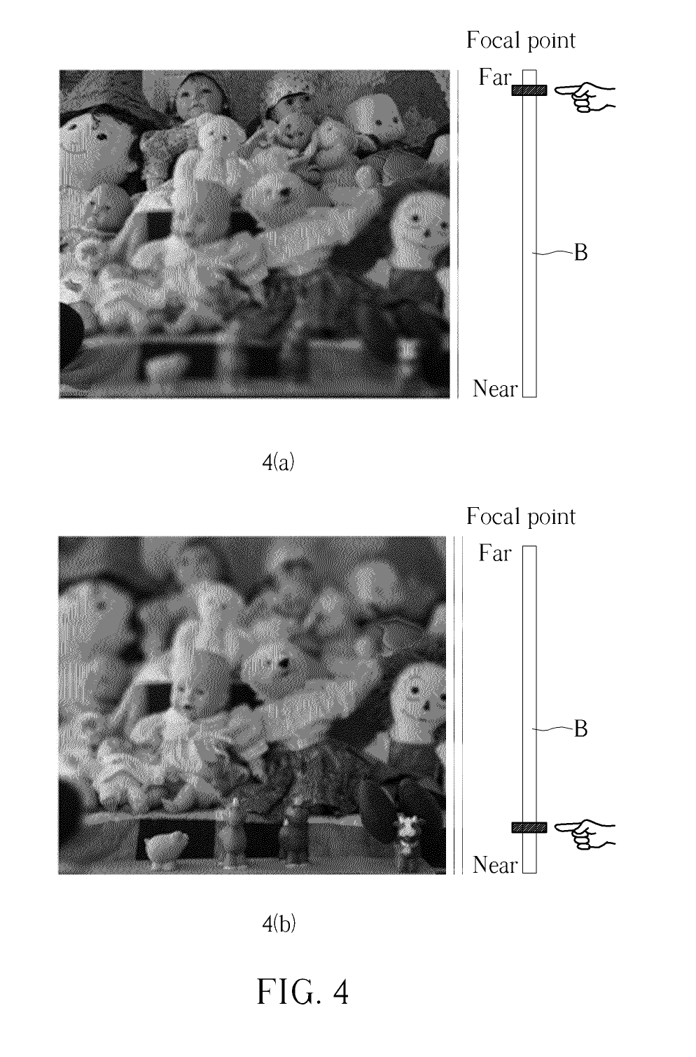

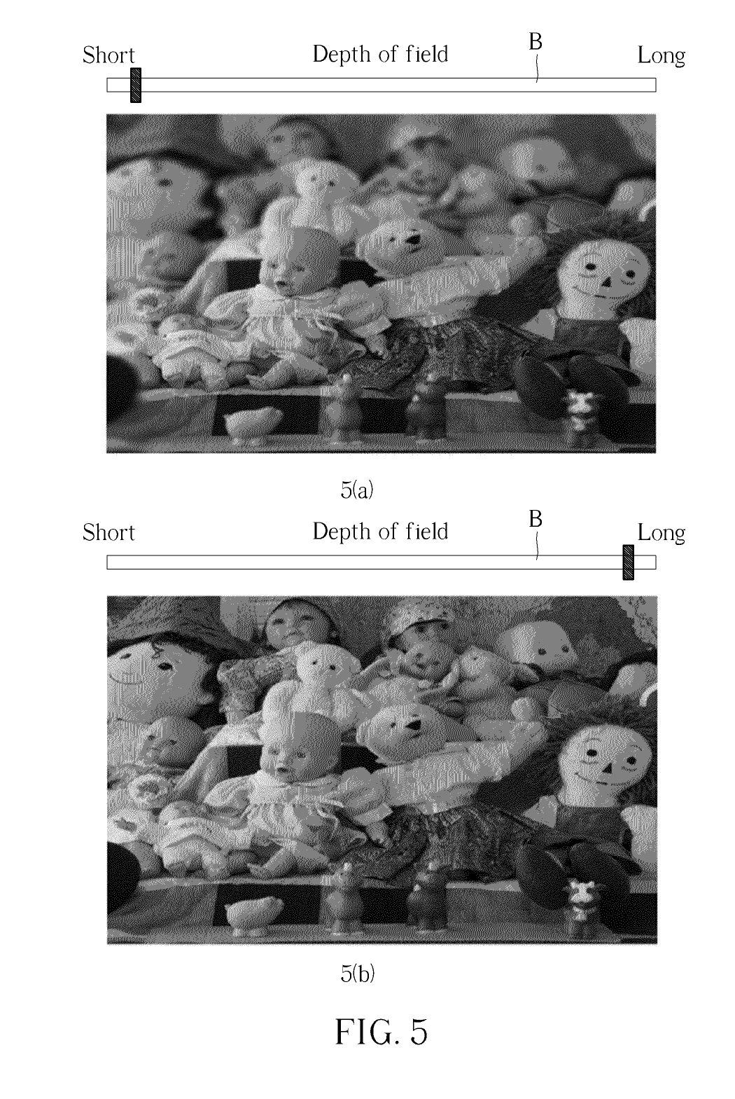

Via above-mentioned steps, the effect for adjusting a focal point or a defocus level for an image can be performed, via generating a processed image according to the depth map. FIG. 4 is a schematic diagram illustrating an example for adjusting a focal point of an image, which comprises sub diagrams FIG. 4(a), FIG. 4(b). In FIG. 4(a), the focal point is set as “far”, thus the objects determined to be far in the image are clear but the objects determined to be near in the image are defocused to be blurred. Oppositely, in FIG. 4(b), the focal point is set as “near”, thus the objects determined to be far in the image are defocused to blurred but the objects determined to be near in the image are clear. FIG. 5 is a schematic diagram illustrating an example for adjusting a depth of field of an image, which comprises sub diagrams FIG. 5(a), FIG. 5(b). In FIG. 5(a) the depth field is set to be short, thus some objects in the image are clear and some are blurred. On the contrary, in FIG. 5(b) the depth field is set to be long, thus all the objects in the image are clear. Since the depth of field is relative with the defocus level of the image, the example in FIG. 5 can be regarded as an example for adjusting a defocus level of an image

Since the user can adjust the focal point or the depth of field via the adjusting bar B in FIG. 4 and FIG. 5, it can be regarded the user sends a focal point setting signal or a defocus level setting signal via the adjusting bar B. Therefore, the method in FIG. 1 can further comprise: receiving a defocus level setting signal to determine a defocus level of the processed image. In such case, the step 105 in FIG. 1 performs the defocus operation according to the depth map and the focal point setting signal, to generate the processed image. Furthermore, the method in FIG. 1 can further comprise: receiving a defocus level setting signal to determine a defocus level of the processed image. In such case, the step 105 in FIG. 1 performs the defocus operation according to the depth map and the defocus level setting signal, to generate the processed image. Please note the user is not limited to control the focal point or the defocus level via the adjusting bar B shown in FIG. 4 and FIG. 5. For example, the user can directly touch a point of the image via a touch screen, to determine the focal point.

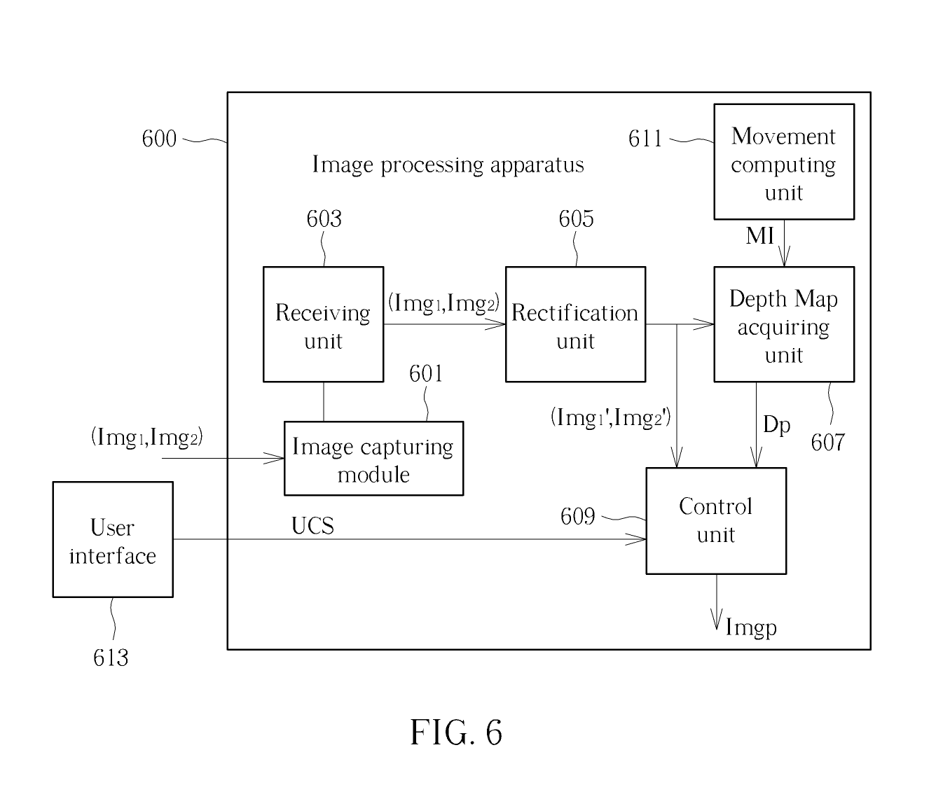

FIG. 6 is a block diagram illustrating an image processing apparatus according to one embodiment of the present application. Please note two 2D images Img₁ and Img₂ are applied as an example, but 2D images or 3D images with other numbers can also be applied to the image processing apparatus 600. As shown in FIG. 6, the image processing apparatus 600 comprises: an image capturing module 601, a receiving unit 603, a rectification 605, a depth map acquiring unit 607, a control unit 609 and a movement computing unit 611. In this embodiment, the image capturing module 601 captures 2D images Img₁, Img₂ and then transmits the 2D images Img₁, Img₂ to the receiving unit 603 as input images. However, please note the image capturing module 601 can be omitted from the image processing apparatus 600 and the receiving unit 603 can receive images from other sources. For example, the receiving unit 603 can receives an original 3D image or 2D images from a storage device or other electronic devices, or from a network. The rectification 605 adjusts at least one of the 2D images Img₁, Img₂ to make sure the 2D images Img₁, Img₂ have the same horizontal level, to generate rectified 2D images Img₁′, Img₂′, such that the depth map can be precisely generated. However, the rectification 605 can be omitted if the alignment for the 2D images Img₁, Img₂ is not seriously concerned. In such case, the depth map acquiring unit 607 and the control unit 609 receive the 2D images Img₁, Img₂ rather than the rectified 2D images Img₁′, Img₂′.

The depth map acquiring unit 607 acquires depth map DP from the at least one input image and transmits the depth map DP to the control unit 609. The control unit performs a defocus operation according to the depth map DP upon one of the 2D images Img₁, Img₂, to generate a processed image Imgp. The movement computing unit 611 can compute the movement information MI for the electronic apparatus which the image processing apparatus 600 is disposed in. The depth map acquiring unit 607 can further refer to the movement information MI to acquire the depth map DP. However, the control unit 609 can generate the depth map DP without referring the movement information MI such that the depth map acquiring unit 607 can be removed from the image processing apparatus 600. Also, the control unit 609 can receive a user control signal USC, which can comprise the focal point setting signal or the defocus level setting signal described in FIG. 4 and FIG. 5. The user control signal USC can be generated by a user interface 613 such as a touch display or a keypad (not limited).

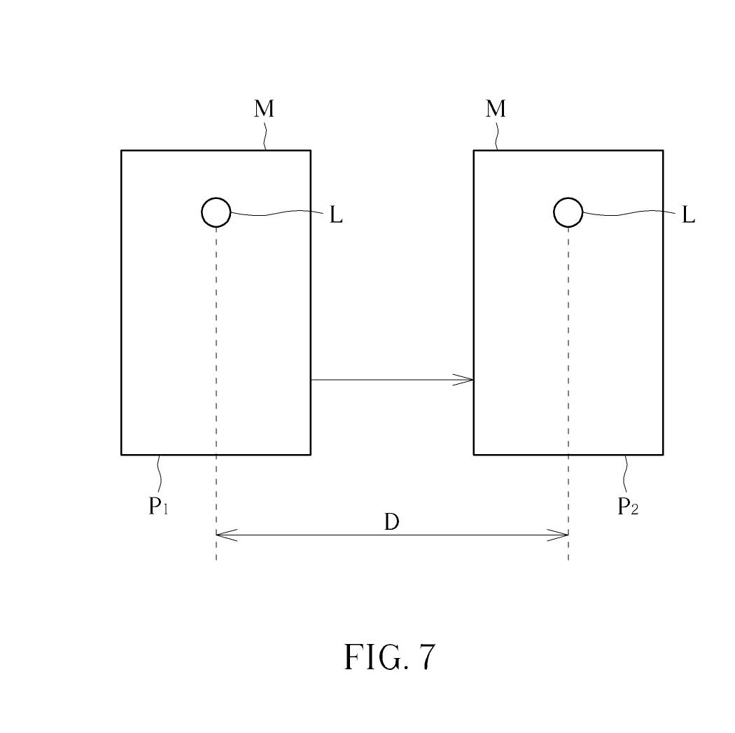

FIG. 7-FIG. 10 are schematic diagrams illustrating the generation for 2D images according to different embodiments of the present application (.Please note these embodiments do not mean to limit the scope of the present application. The 2D images can be acquired via other methods besides the methods illustrated in FIG. 7-FIG. 10.

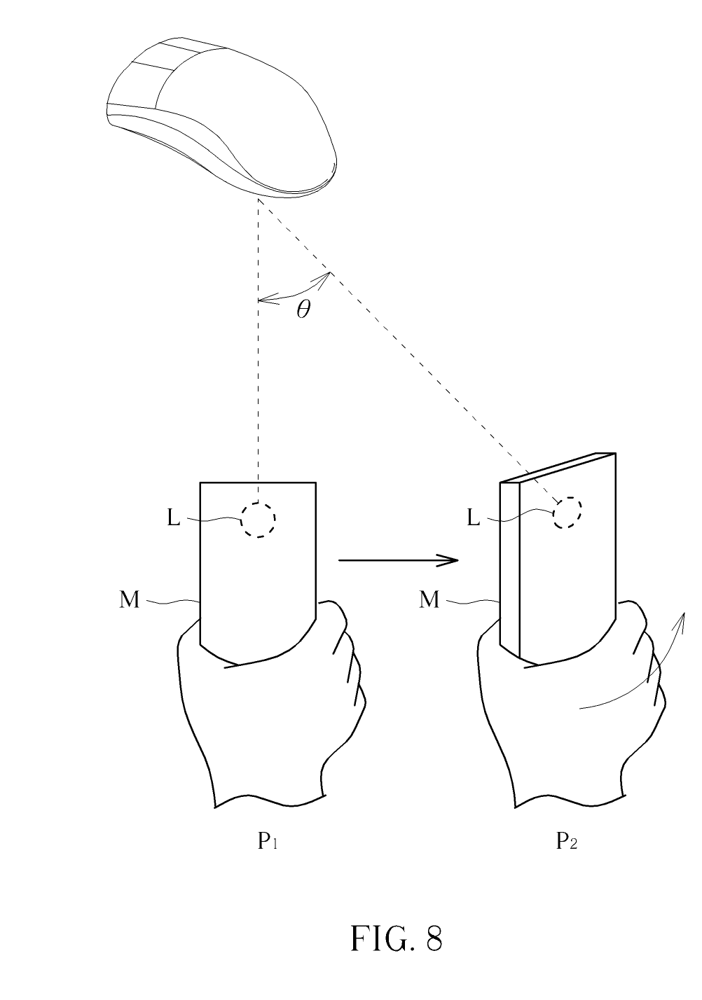

In the embodiments of FIG. 7 and FIG. 8, an image capturing device (ex. camera) with a single lens L is provided to a mobile phone M. Please note the mobile phone M can be replaced by any other electronic device. In the embodiment of FIG. 7, the mobile phone M captures a first 2D image at the position P₁ via the lens L, and then moves for a distance D to a new position P₂ by a translation motion. After that, the mobile phone M captures a second 2D image at the position P₂, wherein these two 2D images of FIG. 7 have different angles of view and may induce better disparity effect accordingly.

In the embodiment of FIG. 8, the mobile phone M captures a first 2D image at the position P₁ via the lens L as well, and then the user shifts and rotates the mobile phone M in a counter clock wise direction for an angle θ to a position P₂ . After that, the mobile phone M also captures a second 2D image at the position P₂. Compared with FIG. 7, these two 2D images of FIG. 8 have relatively the same angle of view and may induce different disparity effect accordingly.

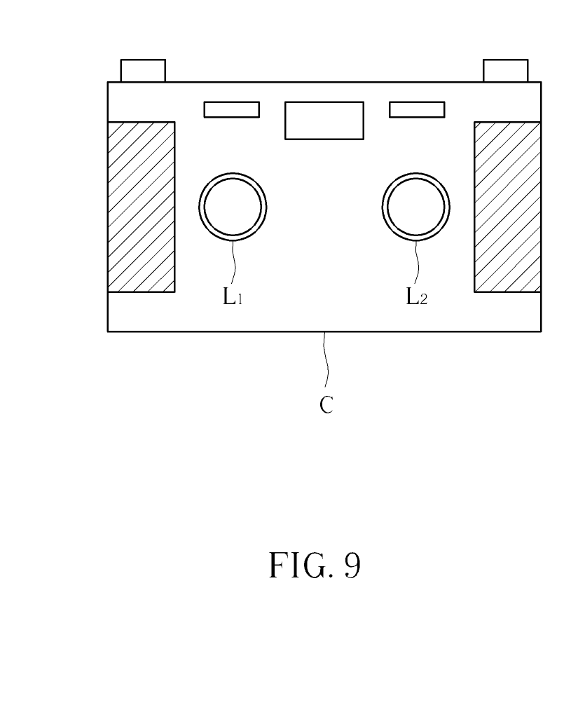

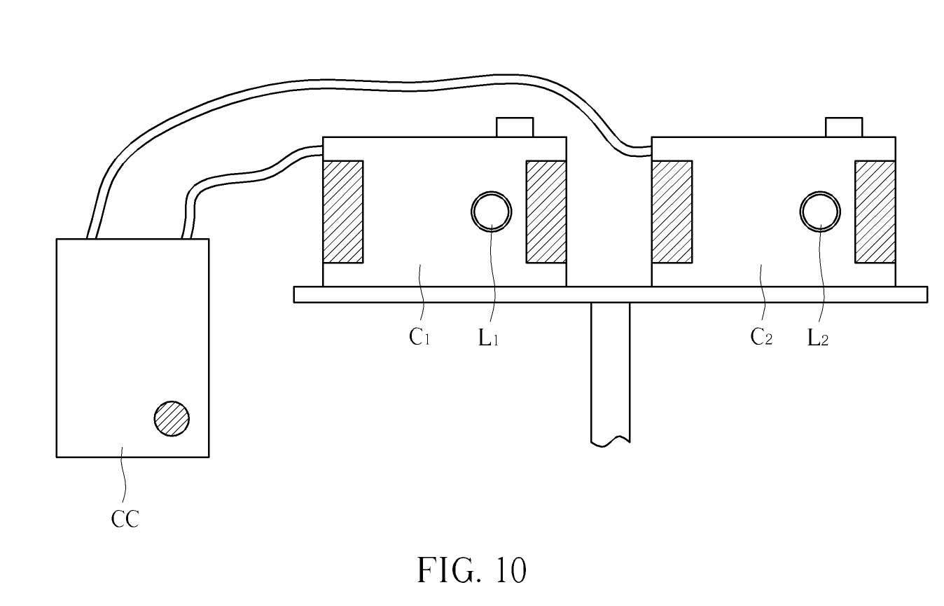

In the embodiment of FIG. 9, a camera C with two lenses L₁ and L₂ is provided. Via the lenses L₁ and L₂, the camera C can respectively capture the first 2D image and the second 2D image via the lenses L₁ and L₂. In the embodiment of FIG. 10, the lenses L₁ and L₂ are respectively provided two different cameras C₁ and C₂ rather than a single camera. The cameras C₁ and C₂ can be controlled by a camera controller CC to respectively capture the first 2D image via the lens L₁ and the second 2D image via the lens L₂. Please note the cameras illustrated in the embodiments of FIG. 9 and FIG. 10 can be replaced by other image capturing devices.

In view of above-mentioned embodiments, via performing defocus operation according to depth map, the focal point and the defocus level (depth of field) can be easily adjusted by a user without an expensive lens and complex algorithms. Also, the 2D images for generating the depth map can be captured by a single camera with a single lens, thus the operation is more convenient for an user and the cost, size for the electronic apparatus in which the camera is disposed can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method, comprising:
(a) receiving at least one input image;
(b) acquiring depth map from the at least one input image; and
(c) performing a defocus operation according to the depth map upon one of the input images to generate a processed image.

2. The image processing method of claim 1, further comprising:
(d) capturing a first 2D image as one of the input images; and
(e) capturing a second 2D image as one of the input images;
wherein the step (b) acquires the depth map from the first 2D image and the second 2D image.

3. The image processing method of claim 2, wherein the step (c) performs the defocus operation upon one of the first 2D image and the second 2D image, to generate the processed image.

4. The image processing method of claim 2,
wherein the step (d) captures the first 2D image via a lens of a image capturing device; and
wherein the step (e) moves the image capturing device to capture the second 2D image via the lens.

5. The image processing method of claim 2,
wherein the step (d) captures the first 2D image via a first lens of a image capturing device; and
wherein the step (e) captures the second 2D image via a second lens of the image capturing device.

6. The image processing method of claim 2,
wherein the step (d) captures the first 2D image via a first image capturing device; and
wherein the step (e) captures the second 2D image via a second image capturing device.

7. The image processing method of claim 1, further comprising:
receiving an original 3D image as the input image;
wherein the step (b) acquires the depth map from the original 3D image.

8. The image processing method of claim 1, wherein the image processing method is applied to an electronic apparatus, wherein the step (b) comprises computing movement information for the electronic apparatus as reference for acquiring the depth map.

9. The image processing method of claim 1, further comprising:
receiving a focal point setting signal to determine a focus point of the processed image;
wherein the step (c) performs the defocus operation according to the depth map and the focal point setting signal, to generate the processed image.

10. The image processing method of claim 1, further comprising:
receiving a defocus level setting signal to determine a defocus level of the processed image;
wherein the step (c) performs the defocus operation according to the depth map and the defocus level setting signal, to generate the processed image.

11. An image processing apparatus, comprising:
a receiving unit, for receiving at least one input image;
a depth map acquiring unit, for acquiring depth map from the at least one input image; and
a control unit, for performing a defocus operation according to the depth map upon one of the input images to generate a processed image.

12. The image processing apparatus of claim 11, further comprising an image capturing module for capturing a first 2D image as one of the input image and for capturing a second 2D image as one of the input images; wherein the depth map acquiring unit acquires the depth map from the first 2D image and the second 2D image.

13. The image processing apparatus of claim 12, wherein the control unit performs the defocus operation upon one of the first 2D image and the second 2D image, to generate the processed image.

14. The image processing apparatus of claim 12, wherein the image capturing module comprises a image capturing device with a lens, wherein the image capturing module captures the first 2D image via the lens of the image capturing device, and capture the second 2D image via the lens if the image capturing device is moved.

15. The image processing apparatus of claim 12, wherein the image capturing module comprises a image capturing device with a first lens and a second lens; wherein the step image capturing module captures the first 2D image via the first lens of the image capturing device; wherein the image capturing module captures the second 2D image via the second lens of the image capturing device.

16. The image processing apparatus of claim 12, wherein the image capturing module comprises a first image capturing device and a second image capturing device; wherein the step image capturing module captures the first 2D image via the first image capturing device, and captures the second 2D image via the second image capturing device.

17. The image processing apparatus of claim 11, wherein the receiving unit receives an original 3D image as the input image; wherein the depth map acquiring unit acquires the depth map from the original 3D image.

18. The image processing apparatus of claim 11, wherein the image processing apparatus is included an electronic apparatus, wherein the image processing apparatus comprises a movement computing unit for computing movement information for the electronic apparatus; wherein the depth map acquiring unit refers the movement information to generate the depth map.

19. The image processing apparatus of claim 11, wherein the control unit receives a focal point setting signal to determine a focus point of the processed image; wherein the control unit performs the defocus operation according to the depth map and the focal point setting signal, to generate the processed image.

20. The image processing apparatus of claim 11, wherein the control unit receives a defocus level setting signal to determine a defocus level of the processed image; wherein the control unit performs the defocus operation according to the depth map and the defocus level setting signal, to generate the processed image.
